(19) United States
(12) Patent Application Publication
(10) Pub. No.: US 2023/0121106 A1
(43) Pub. Date: Apr. 20, 2023

(54) DRIVING-SITUATION-DEPENDENT RANGE FINDING FOR A MOTOR VEHICLE LIDAR SENSOR APPARATUS

(71) Applicant: Valeo Schalter und Sensoren GmbH, Bietigheim-Bissingen (DE)

(72) Inventors: Jan Simon, Bietigheim-Bissingen (DE); Daniel Stricker-Shaver, Bietigheim-Bissingen (DE)

(73) Assignee: Valeo Schalter und Sensoren GmbH, Bietigheim-Bissingen (DE)

(21) Appl. No.: 16/606,459

(22) PCT Filed: Apr. 17, 2018
(86) PCT No.: PCT/EP2018/059712

§ 371 Date: Oct. 18, 2019

(30) Foreign Application Priority Data
Apr. 19, 2017 (DE) 10 2017 108 240.9

(51) Int. Cl. G01S 17/931; G01S 7/4865; G01S 7/4915; G01S 7/481

(52) U.S. Cl. CPC G01S 17/931; G01S 7/4865; G01S 7/4915; G01S 7/4817

(57) ABSTRACT

The invention relates to a computing device (9) for a lidar sensor apparatus (2) for a motor vehicle (1), wherein the computing device (9) has a measurement data interface for receiving measurement data from the lidar sensor device and is configured to ascertain a distance (d) of the object (7) from the lidar sensor apparatus (2) using a time-of-flight measurement for the detected reflected light component (8) or using a phase difference measurement between the scanning light (5) and the detected reflected light component (8), wherein the computing device (9) has a data interface (10) and is configured to automatically utilize the time-of-flight measurement or the phase difference measurement for ascertaining the distance (d) in dependence on at least one driving situation parameter provided via the data interface (10) in order to improve a distance measurement that is to be performed by the lidar sensor apparatus (2).

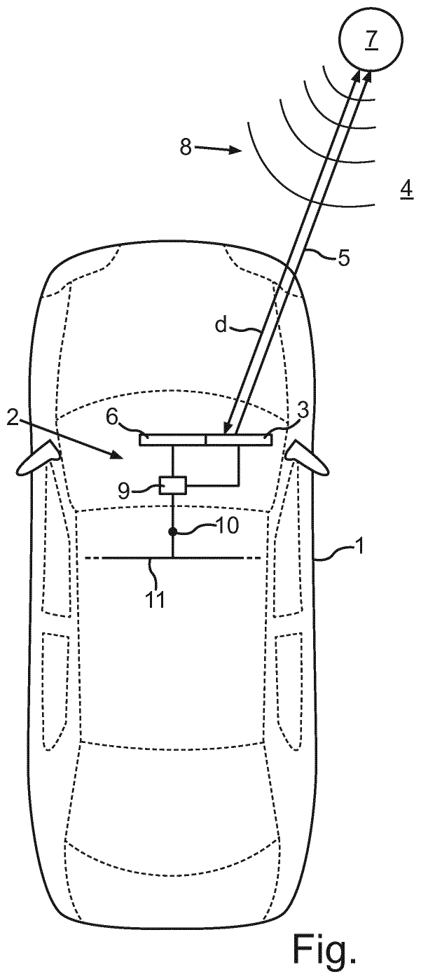

The invention relates to a computing device for a lidar sensor apparatus for a motor vehicle. The computing device has a measurement data interface for receiving measurement data from the lidar sensor device. The computing device is here configured to ascertain a distance of the object from the lidar sensor apparatus using a time-of-flight measurement for the detected reflected light component or using a phase difference measurement between the scanning light and the detected reflected light component. The invention also relates to a method for operating a lidar sensor apparatus of a motor vehicle including scanning the environment of the motor vehicle using the scanning light by way of the scanning device, detecting the light component of the scanning light that is reflected by the object in the environment by way of the detection device, and ascertaining a distance of the object from the lidar sensor apparatus using the time-of-flight measurement for the detected reflected light component or using the phase difference measurement between the scanning light and the detected reflected light component by way of the computing device.

Lidar sensor apparatuses or lidar systems, that is to say light detection and ranging systems, are frequently used in modern motor vehicles for optical range finding and/or speed measurements. In this case, a distance from the object in the environment of the lidar sensor apparatus is calculated from the time of flight of signals that are emitted by the lidar sensor apparatus and are reflected back to the lidar sensor apparatus by the object. The signals may be present for example in the form of scanning light, of which a light component is reflected back to the lidar sensor apparatus.

Consequently, a (temporal) light pulse is emitted in the time-of-flight measurement. The time of flight of said light pulse, of the scanning light, is the time the scanning light takes to be reflected back to the source. By measuring the time of flight Δt, it is possible to ascertain via the speed of light the distance I between the source and the object. The speed of light is here reduced by the surrounding medium, typically air, having the refractive index n, resulting in the relationship I=c*Δt*0.5*n.

The advantage of this method is the short reaction time and the large measurement range, because it allows the ascertainment of distances from one metre up to several tens of kilometres. The disadvantage here is the required measurement of very short time periods, specifically of nanoseconds to picoseconds, with the result that it is difficult to ascertain the distance with a resolution higher than a few centimetres. To reduce the requirements in terms of the time measurement, methods are used in which the scanning light, that is to say for example a laser beam, itself is frequency-modulated or is modulated with a high-frequency signal.

However, a distance can in principle also be ascertained using a phase difference measurements between the scanning light and a detected reflected light component. Accordingly, the phase shift of the reflected light component of the scanning light or the modulation thereof with respect to the emitted scanning light, for example with respect to the emitted laser beam, is distance-dependent. For example, if a laser is used as the scanning light and the laser beam itself is used for the superposition, the corresponding device operates as is known from a laser interferometer. The latter do not measure absolute path lengths but only a relative change in the case of a displacement of the target or of a reference mirror. In the case of a displacement of a mirror or of an object on which the scanning light is reflected, the sum of the emitted and reflected scanning light is periodically modulated as a consequence of an interference. In the case of a displacement of the object by half a light wavelength, the superposition covers exactly one period. If the number of said periods is counted and multiplied by the wavelength of the scanning light, the sought-after path length is obtained. With such an evaluation, an accuracy of approximately a hundredth of the wavelength is achieved, with the result that an accuracy of a few nanometres can be attained in the case of visible light.

For greater distances, it is now possible to operate with a high-frequency modulation of the laser amplitude and correspondingly evaluate not the wavelength of the scanning light, for example of the laser scanning light, but the phase position of the high-frequency signals which have been modulated onto the scanning light. If the emitted scanning light is modulated with a frequency of

$$f = \frac{1}{T} ,$$

the result is the phase difference

$$φ = \frac{Δ t}{T} * 2 π ,$$

wherein Δt is the shortest temporal distance between the identical phase in the emitted scanning light and the detected reflected light component. The distance from the object can thus be calculated as

$$l = c * \frac{T}{4 π} x ( φ + 2 π * m ) = \frac{c}{2} * ( n * T + Δ t ) .$$

Compared to the time-of-flight measurement, these methods of phase difference measurement have the advantage of a higher resolution, which is realizable with a lower outlay in terms of measurement technology. However, the measurement distance is lower on account of the laser necessarily continuously operating with a smaller output. Moreover, the uniqueness of the signals in the case of distances in the case of multiples of half the wavelength of the scanning light is absent.

DE 10 2011 001 387 A1 describes for example a lidar system with which it is possible to determine a distance between an object with a time-of-flight measurement and with a phase difference measurement between an emitted and a received signal.

The object is now to improve a distance measurement that is to be performed by a lidar sensor apparatus in a motor vehicle.

This object is achieved by the subjects of the independent patent claims. Advantageous embodiments are evident from the dependent patent claims, the description and the FIGURE.

The invention relates to a computing device for a lidar sensor apparatus for a motor vehicle. The lidar sensor apparatus for which the computing device is intended can here have a scanning device for scanning an environment of the motor vehicle using scanning light, for example laser scanning light in the form of a laser beam, and a detection device for detecting a light component of the scanning light that is reflected by an object in the environment. The computing device has a measurement data interface for receiving measurement data from the lidar sensor device. The measurement data can here comprise the information relevant for determining the distance. The computing device is here configured to ascertain a distance of the object in the environment of the motor vehicle, or of the lidar sensor apparatus, from the lidar sensor apparatus using a time-of-flight measurement for the detected reflected light component or using a phase difference measurement between the scanning light and the detected reflected light component. Ascertaining can here be understood in the meaning of determining and/or calculating.

What is important here is that the computing device has a data interface and is configured to automatically utilize or activate the time-of-flight measurement or the phase difference measurement for ascertaining the distance in dependence on at least one, that is to say one or more, driving situation parameters provided via the data interface. The distance ascertained by the computing device is thus automatically ascertained, in dependence on the driving situation parameter, either using the time-of-flight measurement for the detected reflected light component or using the phase difference measurement between the scanning light and the detected reflected light component. It is thus possible in dependence on the driving situation parameter to automatically switch, or to automatically switch back and forth, between the time-of-flight measurement and the phase difference measurement.

The driving situation parameter can here be provided by the motor vehicle or by the lidar sensor apparatus via the data interface. When ascertaining the distance using the phase difference measurement, it is also possible for air density correction to be provided, if required. Said air density correction can be provided in dependence on the temperature and/or pressure and/or humidity of the air in the environment. This is due to the fact that the light wavelength is dependent on the refractive index of the air and consequently changes with the temperature, pressure and humidity. It is thus possible for a particularly accurate ascertainment of the distance to be effected. Using the computing device described, it is thus possible to realize a lidar sensor apparatus that can perform both measurement methods, i.e. time-of-flight measurement and phase difference measurement. Depending on the situation, a selection is here automatically made as to which of the two measurement methods makes the most sense in the respective situation.

This has the advantage that the distance is ascertained in each case accurately with the aforementioned advantages, that is to say either with a large range and short reaction time or with reduced outlay with respect to measurement technology and with increased resolution. One and the same measurement system, specifically the lidar sensor apparatus, can thus in the respective driving situation ascertain the distance accordingly or adapted to the respective driving situation using the more advantageous measurement method, as the case may be.

In one advantageous embodiment, the or one of the driving situation parameters comprises or is information relating to a driving speed of the motor vehicle. The computing device can here be configured to utilize or activate the phase difference measurement for ascertaining the distance at a driving speed that is less than a specified limit value, for example less than 20 km/h, and to utilize or activate the time-of-flight measurement at a driving speed that is greater than the specified limit value.

This has the advantage that the driving situation is thus particularly effectively represented by the driving situation parameter and the distance can be automatically provided or ascertained by the computing device with a greater accuracy at lower driving speeds, at which typically smaller distances than at greater driving speeds are important.

In another advantageous embodiment, the or one of the driving situation parameters comprises or is information relating to a location, that is to say a current position, of the motor vehicle. The driving situation parameter can thus be referred to as a location-dependent or position-dependent driving situation parameter. The computing device or the lidar sensor apparatus in this case can have, or be coupled to, a navigation system and/or a position determination system with, for example, a global positioning sensor (GPS sensor). Information as to the use of the phase difference measurement or the time-of-flight measurement for ascertaining the distance can here be coupled to the respective location. The computing device can be configured here to utilize or activate the phase difference measurement for ascertaining the distance if the location belongs to a specified first category and/or to utilize or activate the time-of-flight measurement for ascertaining the distance if the location belongs to a specified second category. In particular, the first category can here comprise car parks and/or multi-storey car parks and/or pedestrian zones, that is to say belong to car parks, multi-storey car parks and/or pedestrian zones of the first category, and/or the second category can comprise motorways and/or dual carriageways.

This has the advantage that the driving situations can be characterized even more effectively, with the result that the distance ascertained can be adapted in terms of its accuracy and speediness of its availability or its range even better to the respective situation. Especially in narrow vicinities, such as car parks, multi-storey car parks or pedestrian zones, distance measurement that is as accurate as possible is advantageous. In wide vicinities, such as motorways and/or dual carriageways, on the other hand, the increased range of the distance ascertainment is advantageous.

In a further advantageous embodiment, the or one of the driving situation parameters comprises or is information relating to an activated driver assistance function of the motor vehicle. The computing device can here be configured for example to utilize or activate the phase difference measurement for ascertaining the distance if a driver assistance function for partially automated and/or fully automated parking is activated. Alternatively or in addition thereto, the computing device can be configured for example to utilize the timeof-flight measurement for ascertaining the distance if a driver assistance function for automated and/or fully automated driving on a motorway or a dual carriageway is activated.

This has the advantage that the property of the distance ascertained that is more relevant for the respective driver assistance function, specifically the accuracy thereof or the range thereof, is adapted to the respective driving situation such that the driver assistance function can also be performed with increased reliability and accordingly the safety during operation of the system is also increased.

In a particularly advantageous embodiment, the computing device is configured to ascertain, after the ascertainment of the distance, the distance again by way of the phase difference measurement if the magnitude of the distance ascertained lies below a limit value and was ascertained using the time-of-flight measurement. Alternatively or in addition thereto, the computing device can also be configured to ascertain, after the ascertainment of the distance, the distance again by way of the time-of-flight measurement if the magnitude of the distance ascertained lies above a further limit value and was ascertained using the phase difference measurement. The further limit value can here in particular be the former limit value or be identical thereto. For example, the former and/or the further limit value can be 20 and/or 15 and/or 10 metres. If the limit values differ, the further limit value is preferably greater than the former limit value.

This has the advantage that always the more reliable method for ascertaining the distance is automatically selected.

In a further advantageous embodiment, an intensity of the already detected reflected light component over a detection period of at least one microsecond, in particular 2 microseconds or more than 2 microseconds, is stored independently of the driving situation parameter provided and thus independently of the method activated for measuring the distance, that is to say always, during the detection. In particular, storing can be effected with a temporal resolution of at least 250 intensity values per microseconds.

This has the advantage that the scanning and the detection can be effected independently of the measurement method selected, that is to say the respective measurement method can be activated after the detection, in other words a decision as to which measurement method is used only has to be made after the detection. This is so because both time-of-flight measurement and phase difference measurement are possible with the stored intensities. Customarily, a respectively ascertained intensity has been forgotten or discarded (that is to say, not stored) in systems of this kind especially when ascertaining a distance using a time-of-flight measurement, which means that in the prior art a new detection process must first be started when changing the measurement method from the time-of-flight measurement to the phase difference measurement.

The invention also relates to a lidar sensor apparatus having a scanning device for scanning an environment of the motor vehicle with the scanning light and having the detection device for detecting the light component of the scanning light that is reflected by the object in the environment and having a computing device according to one or more of the embodiments described.

In a particularly advantageous embodiment of the lidar sensor apparatus, the scanning device has two different light sources for the scanning light and is configured to activate one light source (in particular only) for the time-of-flight measurement and to activate the other light source (in particular only) for the phase difference measurement. Each of the two light sources can here also comprise a plurality of respective individual light sources; in other words, the two light sources can be respective groups of light sources.

This has the advantage that the results of the respective measurement can be optimized by the appropriate hardware, with the result that both an evaluation with the time-of-flight measurement and an evaluation of the phase shift can be easily realized by the sensor apparatus which then has two transmission paths.

The invention also relates to a motor vehicle having a lidar sensor apparatus according to one of the embodiments described.

The invention furthermore relates to a method for operating a lidar sensor apparatus of a motor vehicle having a series of method steps. One method step is here scanning an environment of the motor vehicle with scanning light by way of a scanning device of the lidar sensor apparatus. A further method step is detecting a light component of the scanning light that is reflected by an object in the environment of the motor vehicle by way of a detection device of the lidar sensor apparatus. A subsequent method step is ascertaining a distance of the object from the lidar sensor apparatus using a time-of-flight measurement for the detected reflected light component or using a phase difference measurement between the scanning light and the detected reflected light component by way of a computing device of the lidar sensor apparatus. One important method step is here the step of automatically activating the time-of-flight measurement or the phase difference measurement for measuring the distance in dependence on at least one driving situation parameter provided by the motor vehicle via a data interface of the lidar sensor apparatus or the measurement computing device.

Advantages and advantageous embodiments of the method here correspond to advantages and advantageous embodiments of the computing device and of the lidar sensor apparatus.

The features and combinations of features that are cited in the description above and also the features and combinations of features that are cited in the description of the FIGURES below and/or as shown in the FIGURES alone can be used not only in the respectively indicated combination but also in other combinations without departing from the scope of the invention. Therefore, embodiments of the invention that are not explicitly shown and explained in the FIGURES, but emanate and are producible from the explained embodiments by virtue of self-contained combinations of features, are also intended to be regarded as included and as disclosed. Embodiments and combinations of features that therefore do not have all the features of an independent claim as originally worded are also intended to be regarded as disclosed. Furthermore, embodiments and combinations of features that go beyond or differ from the combinations of features set out in the back-references of the claims, should be considered to be disclosed, in particular by the embodiments set out above.

Exemplary embodiments of the invention will be explained in more detail below with reference to a schematic drawing. The single FIGURE here shows a motor vehicle having an exemplary embodiment of a lidar sensor apparatus.

The motor vehicle 1 here includes the sensor apparatus 2 having a scanning device 3 for scanning an environment 4 of the motor vehicle 1 with scanning light 5 and a detection device 6 for detecting a light component 8 of the scanning light 5 that is reflected by an object 7 in the environment 4. The lidar sensor apparatus 2 moreover includes a computation apparatus 9 that is configured to ascertain a distance d of the object 7 from the lidar sensor apparatus 2 and thus from the motor vehicle 1. This ascertaining is effected in the present case using a time-of-flight measurement for the detected reflected light component or using a phase difference measurement between the scanning light 5 and the detected reflected light component. What is important here is that the computing device 9 has a data interface 10 and is configured to automatically utilize or activate the time-of-flight measurement or the phase difference measurement for ascertaining the distance d in dependence on at least one driving situation parameter provided via the data interface 10. In the present case, the computing device and thus the lidar sensor apparatus 2 is coupled via the data interface 10 to a bus 11, for example a CAN bus of the motor vehicle 1.

It is thus possible here to provide the lidar sensor device, via the bus 11, with information relating to a driving speed of the motor vehicle 1 as a driving situation parameter. It is thus possible to use the phase difference measurement for ascertaining the distance d for example at a low speed under a specified limit value of for example 20 km/h and to use the time-of-flight measurement at an increased driving speed of greater than the specified limit value.

If the driving situation parameter that has been captured comprises information relating to a location of the motor vehicle 1, it is for example also possible to automatically utilize or activate the more accurate measurement mode, that is to say the phase difference measurement, during and after entry into a multi-storey car park. In this way, the accuracy of the distance ascertainment is increased in narrow environments, especially for automated parking procedures.

1. A computing device for a lidar sensor apparatus for a motor vehicle, the computing device comprising:
a measurement data interface for receiving measurement data from the lidar sensor apparatus, wherein the computing device is configured to ascertain a distance of the object from the lidar sensor apparatus using a time-of-flight measurement for the detected reflected light component or using a phase difference measurement between the scanning light and the detected reflected light component; and
a data interface, wherein the computing device is configured to automatically utilize the time-of-flight measurement or the phase difference measurement for ascertaining the distance in dependence on at least one driving situation parameter provided via the data interface.

2. The computing device according to claim 1, wherein the driving situation parameter comprises information relating to a driving speed of the motor vehicle.

3. The computing device according to claim 2, wherein the computing device is configured to utilize the phase difference measurement for ascertaining the distance at a driving speed that is less than a specified limit value, in particular less than 20 km/h, and to utilize the time-of-flight measurement at a driving speed that is greater than the specified limit value.

4. The computing device according to claim 1, wherein the driving situation parameter comprises information relating to a location of the motor vehicle.

5. The computing device according to claim 4, wherein the computing device is configured to utilize the phase difference measurement for ascertaining the distance if the location belongs to a specified first category, which comprises in particular car parks and/or multi-story car parks and/or pedestrian zones, and/or to utilize the time-of-flight measurement for ascertaining the distance if the location belongs to a specified second category, which comprises in particular motorways and/or dual carriageways.

6. The computing device according to claim 1, wherein the driving situation parameter comprises information relating to an activated driver assistance function of the motor vehicle.

7. The computing device according to claim 6, wherein the computing device is configured to utilize the phase difference measurement for ascertaining the distance if a driver assistance function for partially automated and/or fully automated parking is activated.

8. The computing device according to claim 1, wherein the computing device is configured to ascertain, after the ascertainment of the distance, the distance again by way of the phase difference measurement if the magnitude of the distance ascertained lies below a limit value and was ascertained using the time-of-flight measurement and to ascertain, after the ascertainment of the distance, the distance again by way of the time-of-flight measurement if the magnitude of the distance ascertained lies above a further limit value, which is in particular the former limit value, and was ascertained using the phase difference measurement.

9. The computing device according to claim 1, wherein an intensity of the detected reflected light component over a detection period of at least 1 μs, in particular 2 μs or more than 2 μs, is stored independently of the driving situation parameter provided, in particular with a temporal resolution of at least 250 intensity values per microsecond.

10. A lidar sensor apparatus, comprising:
a scanning device for scanning the environment of the motor vehicle with the scanning light; and
a detection device for detecting the light component of the scanning light reflected by the object in the environment; and
a computing device comprising:
a measurement data interface for receiving measurement data from the lidar sensor apparatus, wherein the computing device is configured to ascertain a distance of the object from the lidar sensor apparatus using a time-of-flight measurement for the detected reflected light component or using a phase difference measurement between the scanning light and the detected reflected light component, and
a data interface, wherein the computing device is configured to automatically utilize the time-of-flight measurement or the phase difference measurement for ascertaining the distance in dependence on at least one driving situation parameter provided via the data interface.

11. The lidar sensor apparatus according to claim 9, wherein the scanning device has two light sources for the scanning light and is configured to activate one light source for the time-of-flight measurement and to activate the other light source for the phase difference measurement.

12. A motor vehicle having a lidar sensor apparatus according to claim 1.

13. A method for operating a lidar sensor apparatus of a motor vehicle, the method comprising:
scanning an environment of the motor vehicle with scanning light by way of a scanning device of the lidar sensor apparatus;
detecting a light component of the scanning light that is reflected by an object in the environment by way of a detection device of the lidar sensor apparatus;
ascertaining a distance of the object from the lidar sensor apparatus using a time-of-flight measurement for the detected reflected light component or using a phase difference measurement between the scanning light and the detected reflected light component by way of a computing device of the lidar sensor apparatus; and
automatically activating the time-of-flight measurement or the phase difference measurement for measuring the distance in dependence on at least one driving situation parameter provided by the motor vehicle via a data interface.
